(19) United States
(12) Patent Application Publication
(10) Pub. No.: US 2007/0242791 A1
(43) Pub. Date: Oct. 18, 2007

(54) Process for Producing Pellets of a Nuclear Fuel Based on a (U, Pu)02 or (U, Th)02 Mixed Oxide

(76) Inventors: Sylvie Dubois, Le Ste Reparade (FR); Cecilia Gilles, Aix en Provence (FR)

Correspondence Address: Robert E. Krebs;Thelen Reid & Priest, P.O. Box 640640, San Jose, CA, 95164-0640, US

(21) Appl. No.: 10/574,878

(22) PCT Filed: Oct. 5, 2004
(86) PCT No.: PCT/FR04/50483

§ 371 Date: Feb. 6, 2007

(30) Foreign Application Priority Data
Oct. 6, 2003 (FR) 0311683

(51) Int. Cl. G21C 3/62

(52) U.S. Cl. 376/409

(57) ABSTRACT

The invention relates to a process for producing pellets of a nuclear fuel based on a (U,Pu)O₂ or (U,Th)O₂ mixed oxide which comprises a) preparing a primary mixture of powders by co-milling a UO₂ powder P1 and a PuO₂ or ThO₂ powder P2, b) sieving this mixture, c) preparing a final mixture of powders by diluting the undersize with a UO₂ powder P3, d) pelleting this final mixture, and e) sintering the pellets, and in which at least one compound is incorporated chosen from the group consisting of the oxides of Cr, Al, Ti, Mg, V and Nb, precursors thereof and inorganic compounds capable of providing the element sulphur during step e), is incorporated in at least one of the powders P1, P2 and P3 and/or in at least one of the primary or final mixture of powders.

### TECHNICAL FIELD

The invention relates to a process for producing pellets of a nuclear fuel based on a uranium and plutonium or uranium and thorium mixed oxide.

In particular, the invention relates to a process enabling pellets to be prepared of a nuclear fuel based on a (U,PU)O₂ mixed oxide—or MOX fuel—which have a heterogeneous microstructure, namely formed of at least two distinct phases, one called a uraniferous phase since it is substantially free from plutonium, and the other called a plutoniferous phase since it is rich in plutonium, and which are characterized at the same time by a volume increase of the plutoniferous phase and by an increase in the particle size of this phase compared with those observed in pellets of MOX fuel with a heterogeneous microstructure produced up to now.

Such pellets are of great value for the production of fuel rods intended for many types of nuclear reactors, particularly light water reactors.

### STATE OF THE PRIOR ART

The fuel that is used in the core of a nuclear reactor has the function of providing energy in the form of heat by fission of nuclides (uranium, plutonium, thorium etc.) that it contains, under the action of neutrons.

In any operating situation, this fuel should simultaneously satisfy several criteria of which the most important are:

1. to evacuate thermal energy, released by fission, to the heat transfer medium, which in turn ensures evacuation outside the core of the reactor.

2. to withstand any variations in the power of the reactor without losing its integrity.

3. to confine fission products: the fuel is actually designed and made in such a way as to prevent the fission or capture products produced by nuclear reactions from escaping from the core of the reactor.

To this end, the active material is enclosed in a sealed envelope, called cladding, which constitutes what nuclear safety specialists call the “first safety barrier”. The integrity of this cladding must be perfect and remain so for all the time the fuel remains in the reactor.

This requirement is directly linked to the preceding criterion, some transitory power regimes inducing, in point of fact, Pellet Cladding Mechanical Interactions (PCMI) following an expansion of the pellets, which are likely to bring about, in some cases, rupture of the cladding and, on leaving, the passage of fission products into the heat transfer fluid.

Thus, this confinement criterion, which affects nuclear safety, must be above all satisfactory.

4. to limit the release of fission gases: actually, the release of these gases, which is an inevitable phenomenon, must be reduced to the maximum in order to slow down as much as possible the increase in pressure inside the cladding, too high a rise in this pressure being also likely to lead to a rupture of this cladding and the release of fission products into the heat transfer fluid.

This fourth criterion is a determining factor in terms of economic viability, and one of the objectives of the nuclear industry is to arrive at an increase in the rate of combustion of fuels so as to optimize the management of these.

As regards MOX nuclear fuels, based on a (U,Pu)O₂ mixed oxide, the processes proposed at the present time for their production are divided into two large families:

the first family which groups together processes called “direct co-milling” processes, in which a UO₂ powder and a PuO₂ Powder are mixed and immediately co-milled in the desired proportions so as to obtain the specified plutonium content, namely the plutonium content that the fuel possesses at the end of production, and the resulting mixture is pelleted and then sintered; and

a second family which groups together processes called “Grinding-Dilution” processes, in which a primary mixture of powders is prepared at the start that is “super-concentrated” in plutonium in relation to the specified content, which is secondarily diluted by adding uranium dioxide so as to obtain a final mixture of powders; it is this final mixture that is pelleted and sintered.

In this second family of processes, the reference process is the MIMAS (MIcronized MASter Batch Blend) process in which a charge of powders is subjected to pelleting and then sintering and is prepared as follows:

producing a primary mixture of powders with a plutonium content greater than the specified plutonium content, by co-milling a UO₂ powder, a PuO₂ powder and optionally chamotte (namely a mixed uranium and plutonium powder derived from recycling production rejects) until a micronized and intimately mixed powder is obtained;

producing a final mixture of powders having the specified plutonium content by diluting the powder micronized in this way with a UO₂ powder and optionally chamotte, and in which additives are incorporated that are intended to facilitate pelleting of this final mixture (lubricant) and/or are intended to produce a particular porosity during sintering (porogenic agent).

The two families of processes referred to above lead to MOX fuels having very different microstructures.

Thus, MOX fuels obtained by direct co-milling processes are characterized by a uniform distribution of uranium and plutonium in the form of a single (U,Pu)O₂ phase with a plutonium content close to the specified content, this uniformity of distribution resulting from chemical inter-diffusion of U and Pu cations under the effect of the sintering temperature (≈1700° C.).

On the other hand, in “Milling-Dilution” processes, the inter-diffusion coefficients of the U and Pu cations are low, so that following sintering, the primary mixture of powders exists in fuels in the form of plutonium-rich (U,Pu)O₂ clusters (these clusters correspond to agglomerates forming during milling) dispersed in a UO₂ matrix. The result of this is that MOX fuels produced by “Milling-Dilution” methods have a typical microstructure composed of three phases, namely:

a predominant UO₂ uraniferous phase, free from plutonium;

a phase consisting of plutonium-rich (U,Pu)O₂ plutoniferous clusters which are the mark of the primary mixture super-concentrated in plutonium; thus, their mass plutonium content is, for example, of the order of 30%; and

a (U,Pu)O₂ covering phase with an intermediate plutonium content, for example of the order of 10%.

It may appear absurd at first sight to give preference to processes of the “Milling-Dilution” type since they result in homogeneity of the mixture of powders subjected to pelleting and sintering and, consequently, fuels inferior to that obtained by direct co-milling processes, with a local excess concentration in plutonium which brings about increased release of fission gases compared with that observed for an MOX fuel with a uniformly distributed mean plutonium content.

In reality, this is not the case in as much as it has been verified that, during power ramps, no rupture of the cladding, linked to any pellet-cladding interactions, has occurred with MOX fuels produced by a “Milling-Dilution” process, which is a determining criterion as regards safety.

Moreover, MOX fuels derived from “Milling-Dilution” methods are easier to reprocess, once irradiated, than those obtained by direct co-milling methods, and their production rejects are also easier to recycle.

A real need however exists for MOX fuels which, while being produced by a “Milling-Dilution” process, have greater homogeneity than that observed in MOX fuels obtained up to now by this type of method, and in particular better distribution of plutoniferous (U/Pu)O₂ clusters within the UO₂ matrix, so as to reduce the release of gases, in particular in transitory power regimes, and in this way to optimize their use.

Application EP-A-1 081 716 [1] proposes, in order to obtain a more homogeneous plutonium distribution in pellets of an MOX fuel produced by a process of the MIMAS type, to dilute the UO₂/PuO₂ primary mixture with beads 20 to 50 μm in diameter, these beads being obtained by precipitating, in an ammonia bath, fine droplets of an aqueous solution of uranyl nitrate containing 0.5 to 2% organic thickeners of the cellulose ether or dextran type, and then subjecting the beads thus formed, after washing and drying by azeotropic distillation, to a thermal treatment, first of all in an oxidizing atmosphere so as to convert them into uranium sesqioxide (U₃O₈), and then in a reducing atmosphere to concert them into UO₂.

As a variant, application EP-A-1 081 716 proposes to prepare the UO₂/PuO₂ primary mixture with beads obtained in a similar manner but from uranyl-plutonium nitrate.

It should be noted that no indication is provided in this document as to the gain actually obtained as regards the homogeneity of plutonium distribution.

Application FR-A-2 738 076, corresponding to patent US-A-5,841,200, [2] describes a process of the MIMAS type enabling pellets of an MOX fuel to be produced that have a greater particle size while being capable of being, on the one hand surface ground dry and, on the other hand, of dissolving in nitric solutions conventionally used for reprocessing of irradiated nuclear fuels.

In this method, an organic wax of formula C₁₇H₃₇NO₃S is added to the UO₂/PuO₂ primary mixture at a mass concentration of 0.1 to 1%.

Addition of this wax has the effect of facilitating the distribution of the PuO₂ powder within the primary mixture of UO₂/PuO₂ powders, which results in an improvement in the distribution of plutonium in the (U,Pu)O₂ plutoniferous clusters derived from the primary mixture of powders. It also has the effect of reducing the formation of agglomerates during the co-milling of these powders, of improving the ability of the final mixture to flow, and of increasing the particle size in plutonium-rich zones.

On the other hand, this document does not report any effect of the wax on the distribution of (U/Pu)O₂ plutoniferous clusters in the UO₂ matrix.

The Inventors therefore decided that the objective would be to provide a “Milling-Dilution” process for producing pellets of a nuclear fuel based on a uranium and plutonium mixed oxide which leads to pellets having greater homogeneity and in particular more homogeneous distribution of (U/Pu)O₂ plutoniferous clusters within the UO₂ matrix, than MOX fuel pellets produced up to now by the conventional MIMAS process.

### STATEMENT OF THE INVENTION

This objective is achieved by the present invention which provides a process for producing pellets of a nuclear fuel based on a (U,Pu)O₂ or (U,Th)O₂ mixed oxide having a specified plutonium or thorium content, which method comprises the following steps:

a) preparing a primary mixture of powders having a plutonium or thorium content greater than the specified content of the fuel, by co-milling a UO₂ powder P1 and a powder PuO₂ or ThO₂ powder P2,

b) sieving the primary mixture of powders,

c) preparing a final mixture of powders having the specified plutonium or thorium content of the fuel by mixing the undersize obtained in step b) with a UO₂ powder P3 and, optionally, one or more additives,

d) pelleting the final mixture of powders obtained in this way, and

e) sintering the pellets obtained,

and is characterized in that at least one compound chosen from the group consisting of the oxides of chromium, aluminium, titanium, magnesium, vanadium and niobium, precursors of these oxides and inorganic compounds capable of providing the element sulphur during step e), is incorporated into at least one of the powders P1, P2 and P3 and/or into at least one of the primary or final mixture of powders.

Thus, the process according to the invention is a process which repeats the essential features of the MIMAS process, but in which the charge of powders intended to be pelleted and sintered contains at least one oxide of chromium, aluminium, titanium, magnesium, vanadium and niobium, or a precursor of one of these oxides or an inorganic compound capable of providing the pellets with sulphur while they are being sintered, the Inventors having, in point of fact, found that the presence of such a compound in the said charge of powders surprisingly results in a greater volumetric distribution of plutonium in the pellets following sintering, resulting in a greater homogeneity of these pellets, and in particular a more homogeneous distribution of (U,Pu)O₂ plutoniferous clusters in the UO₂ matrix.

The Inventors have also found that a similar benefit is obtained on the volumetric distribution of thorium in the case of fuel pellets based on a (U,Th)O₂ mixed oxide. Within the meaning of the present invention, a precursor of an oxide of chromium, aluminium, titanium, magnesium, vanadium or niobium is understood to be any compound capable of forming such an oxide in pellets while they are being sintered, namely during step e) of the process.

It should be noted that the use of metal oxides and sulphur-containing compounds in the production of nuclear fuel pellets is not novel in itself.

Thus, the use f metal oxides has already been proposed in U.S. Pat. No. 6,235,223 [3] for improving the retention of fission gases in pellets of a (U,Pu)O₂ mixed oxide fuel prepared by a direct co-milling process. Similarly, it has been proposed in international application PCT WO-A-00/49621 [4] to add chromium in the form of Cr₂O₃ to a fuel based on UO₂, ThO₂ or PuO₂, also with the aim of increasing the retention time for fission gases in this fuel.

In addition, application FR-A-2 827 071 [5] describes a process for producing a fuel based on UO₂ or a (U,PU)O₂ mixed oxide which is also intended to improve the retention of fission gases and in which all or part of the UO₂ powder used is first of all treated with a sulphur-containing gas such as CS₂ or H₂S so that it contains sulphur, in particular in the uranium oxysulphide form.

What, on the other hand, is novel is the fact of using metal oxides and inorganic sulphur-containing compounds in a process of the MIMAS type, and what is totally unexpected is that this use results in a greater volumetric distribution of plutonium or thorium accompanied by an enlargement of the particle size.

According to a first preferred embodiment of the process according to the invention, the compound is chromium sesquioxide (Cr₂O₃) or a precursor thereof such as, for example, ammonium chromate of formula (NH₄)₂CrO₄, chromium acetate of formula Cr(CH₃COO)₃ or chromium nitrate of formula Cr(NO₃)₃.

When the compound is Cr₂O₃ it is then preferably present in the final mixture of powders in a mass proportion from 500 to 5000 ppm and, better still, from 1500 to 3000 ppm. If a precursor of this oxide is involved, the quantity of precursor present in the final mixture of powders is adjusted so as to give the pellets, during step e), a mass proportion of Cr₂O₃ within the aforementioned ranges.

As a variant, the compound may also be aluminium trioxide Al₂O₃, titanium dioxide TiO₂ or titanium trioxide Ti₂O₃, magnesium oxide MgO, vanadium pentoxide V₂O₅, or niobium pentoxide Nb₂O₅.

According to another variant of the process according to the invention, the compound is an inorganic compound capable of providing the elements sulphur during step e) of this process.

According to the invention, this compound is preferably uranium oxysulphide (UOS) but it may also be another compound of the U—O—S ternary system such as UO₂SO₃, or a sulphur-containing compound not belonging to this system such as, for example, US₂ or (NH₄)N(SO₃NH₄)₂.

When the compound is a compound capable of providing sulphur, it is then preferably present in the final mixture of powders in a mass proportion such that it enables the pellets to be provided with 50 to 2000 ppm of elementary sulphur and, better still, 50 to 1000 ppm of elementary sulphur. Thus, for example, if this compound is UOS, the mass content of the final mixture of powders in UOS is preferably 440 to 18000 ppm (0.044%-1.8%) and, in a particularly preferred manner, 440 to 9000 ppm (0.044%-0.9%).

As previously mentioned, the compound may be incorporated in one or more of the powders P1 (UO₂), P2 (PuO2 or ThO₂) and P3 (UO₂) used for preparing primary and final mixtures of powders. It is however preferred to incorporate it directly into one of these mixtures or, as a variant, in these two mixtures, for reasons of simplicity of application.

When all or part of the compound is incorporated in the primary mixture of powders, this incorporation is made either during step a), in which case the compound is milled jointly with the powders P1 and P2, or between step a) and step b) of the process, in which case the latter comprises a supplementary step which consists of mixing the primary mixture obtained in step a) with the compound, until a homogeneous whole is obtained.

This mixing operation is preferably carried out in an energy mixer such as a turbine mixer or a cutting mill.

When all or part of the compound is incorporated in the final mixture of powders, this incorporation is preferably made during step c), in which case the undersize obtained in step b) is mixed with the compound and any additive or additives until a homogeneous whole is obtained.

This mixing operation is preferably carried out in a gently-acting mixer, for example of the Turbula type with an oscillo-rotary movement, so as to prevent the powder agglomerates forming the undersize from breaking.

In all cases, the compound is preferably used in powdered form.

According to the invention, step a) for preparing the primary mixture of powders is carried out by co-milling, for example in a ball mill, the powders P1 (UO₂) and P2 (PuO₂ or ThO₂), optionally in the presence of the compound, in proportions such that the mass content of plutonium or thorium in this mixture lies between 25 and 35%.

This co-milling, which may also be carried out in another type of mill, such as for example an attrition mill or a gas jet mill, generally lasts 3 to 6 hours. It induces the formation of powder agglomerates leading to a very extended particle size spectrum of the mixture coming from the mill, from a few μm (microns) to more than 1 mm.

Step b) of sieving the primary mixture of powders, which serves to grade this mixture, is carried out by means of a sieve, for example one made of stainless steel, preferably having openings of a size less than or equal to 250 μm so that only powder agglomerates are kept having the size that is at most equal to this dimension.

Step c) is carried out in order to bring the mass content of plutonium or thorium of the final mixture of powders to a value of 3 to 12%.

According to the invention, chamotte derived from recycling production rejects may be added, either to the primary mixture of powders, or furthermore to both.

In addition, the additive or additives likely to be incorporated in the final mixture of powders during step c) are essentially one or more lubricants designed to facilitate pelleting of this mixture, such as zinc stearate or aluminium stearate, and/or one or more porogenic agents intended to lower and control the density of pellets such as azodoicarbonamide, known under the trade name AZB, this lubricating agent or these lubricating agents and this porogenic agent or these porogenic agents being preferably added in respective proportions not exceeding 0.5% by mass of the total mass of the final mixture of powders.

Step d) for pelleting the final mixture of powders is carried out by means of a press, for example a hydraulic press, of which the parameters are optimized and checked according to the geometric characteristics and appearance of the pellets obtained, by regular sampling. A suitable pressure is, for example, 500 MPa.

The sintering step e) is preferably carried out at a temperature of 1700° C. or approaching this, in a gaseous atmosphere leading to an oxygen potential ΔGO₂ of −476 to −372 KJ/mol at the sintering temperature. Thus, it may in particular consist of a humidified mixture of argon and hydrogen containing 5% hydrogen and of which the water content is from 100 to 2500 ppm, this water content being preferably approximately 850 ppm in the case where the pellets contain Cr₂O₃ and approximately 1000 ppm, in the case where they contain UOS.

Following sintering, the pellets may be subjected to surface finishing, which may be carried out dry on a centreless grinding machine, so as to obtain pellets satisfying the diameter specification.

The pellets obtained by the process according to the invention have the following properties:

a hydrostatic density of the order of 95 to 97% of the theoretical density;

a microstructure characterized, on the basis of optical analyses (optical microscope), by two distinct phases: a uraniferous phase containing little or no plutonium and a plutoniferous phase or thoriferous phase containing plutonium or thorium in an appreciable quantity;

a microstructure characterized, on the basis of electron analyses (SEM or electron microsound or Castaing microsound), by two to four distinct phases according to the precision with which the plutonium or thorium concentration is measured;

a plutoniferous or thoriferous phase which, on the basis of optical analyses, appears to occupy at least 50%, generally more than 60%, and may reach 70% and even 80% of the total volume of the pellets and which, on the basis of electron analyses, appears to occupy more than 70%, and may reach 95%, of the total volume of the pellets.

As a comparison, the plutoniferous phase of an MOX fuel produced by the conventional MIMAS process appears to represent, on the basis of optical analyses, at best 45% of the total volume of the pellets and, on the basis of electron analyses, at best 64% of this volume.

Moreover, electron microsound analyses show that, in pellets obtained by the process according to the invention, the reduction in volume occupied by the uraniferous phase is accompanied by a reduction in the volume occupied by the plutoniferous or thoriferous clusters, and this in preference to a covering phase with an intermediate plutonium or thorium content which increases by a factor at least equal to 1.5 and generally between 1.6 and 2, resulting in greater homogeneity of these pellets, and in particular a more homogeneous distribution of the plutoniferous or thoriferous clusters in the UO₂ matrix.

In addition, chemical attack of each of the phases making up the pellets after sintering reveals a particle size of approximately 5-6 μm in the uraniferous phase, while it generally lies between 10 and 20 μm and may reach 40 or even 50 μm, in the plutoniferous or thoriferous phase.

As a comparison, the particle size of the plutoniferous phase of an MOX fuel produced by the conventional MIMAS process is 5-6 μm, as is that of the particles of the uraniferous phase.

Thus, with a more homogeneous distribution of plutonium or thorium, pellets obtained by the process according to the invention combine a greater particle size in the plutoniferous or thoriferous phase, making it possible to forecast a significant increase in the performance of the fuel in the reactor by a reduction in the local combustion rates and, consequently, a reduction in the release of fission gases.

It should be noted that obtaining two phenomena simultaneously, namely the more homogeneous distribution of plutonium or thorium and the greater increase in particle size in the plutoniferous or thoriferous phase is observed independently of the step in which incorporation of the compound is carried out.

The subject of the invention is also pellets of a nuclear fuel based on a uranium and plutonium mixed oxide or uranium and thorium mixed oxide, capable of being obtained by a process such as previously defined.

Other features and advantages of the invention will become more apparent on reading the remainder of the description, which relates to examples of the production of pellets of nuclear fuels based on a (U,Pu)O₂ mixed oxide by the process according to the invention, and which refers to the appended drawings.

The following examples are of course only given as illustrations of the subject of the invention and in no case constitute a limitation to this subject.

### BRIEF DESCRIPTION OF THE DRAWINGS

FIG. 1 corresponds to a photograph taken with an optical microscope and showing the microstructure of fuel pellets based on a (U,Pu)O₂ mixed oxide produced by a first example of an embodiment of the process according to the invention using Cr₂O₃ as an additive.

FIG. 2 corresponds to two photographs, A and B respectively, taken by an optical microscope at two different magnifications and showing the microstructure of fuel pellets based on a (U,Pu)O₂ mixed oxide produced by a process similar to that used to produce the pellet of which the microstructure is shown in FIG. 1, but without the addition of Cr₂O₃.

FIG. 3 corresponds to a photograph taken with an optical microscope and showing the microstructure of fuel pellets based on a (U,Pu)O₂ mixed oxide produced by a second example of an embodiment of the process according to the invention using Cr₂O₃ as an additive.

FIG. 4 corresponds to a photograph taken with an optical microscope and showing the microstructure of fuel pellets based on a (U,Pu)O₂ mixed oxide produced by a third example of an embodiment of the process according to the invention using Cr₂O₃ as an additive.

FIG. 5 corresponds to two photographs, A and B respectively, taken by an optical microscope at two different magnifications and showing the microstructure of fuel pellets based on a (U,Pu)O₂ mixed oxide produced by a fourth example of an embodiment of the process according to the invention using UOS as an additive.

FIG. 6 corresponds to a photograph taken by an optical microscope and showing the microstructure of fuel pellets based on a (U,Pu)O₂ mixed oxide produced by a fifth example of an embodiment of the process according to the invention using UOS as an additive.

### EXAMPLES OF EMBODIMENTS OF THE PROCESS ACCORDING TO THE INVENTION

### Example 1

748.3 g of a primary mixture of powders (or mixture MP1) having a mass plutonium content of 25% was prepared by co-milling 543.7 g of a UO₂ powder (U/O˜2.18) and 204.6 g of a PuO₂ powder in a ball mill jar for 4 hours.

Following this milling, 8 g of the MP1 mixture were stirred with 0.04 g of Cr₂O₃ (corresponding to a mass proportion of 5000 ppm) in a turbine mixer (speed of rotation of the vessel 10 rpm; speed of rotation of the turbine: 3000 rpm) for 3 cycles of 10 minutes each.

The resulting mixture was sieved through a sieve of which the openings had a size of 80 μm so as to retain only powder agglomerates with a size less than or equal to 80 μm.

8.04 g of the undersize were then mixed with 12 g of a UO₂ powder identical to that used to prepare the MP1 mixture, in the presence of 0.06 g of zinc stearate (ZnSt) in order to obtain a final mixture of powders having a mass content of plutonium of 11%.

This final mixture was prepared in a Turbula mixer for 30 minutes and at a speed of 60 rpm. Its mass composition was as follows: 88.5% of UO₂, 11% of PuO₂, 0.2% of Cr₂O₃ and 0.3% of ZnSt.

It was then pelleted with the aid of a hydraulic press, at a pressure of 500 MPa. The pellets obtained had a cylindrical geometry characterized by a height and diameter close to 6 μm.

They were subjected to sintering at 1700° C. in a hydrogen-containing argon atmosphere (95% Ar/5% H₂) and humidified with 850 ppm of water (pH₂/pH₂O˜60), which made it possible to guarantee an oxygen potential ΔGO₂ of approximately −410 KJ/mol thermodynamically favourable to the appearance of a liquid phase favouring particle size growth.

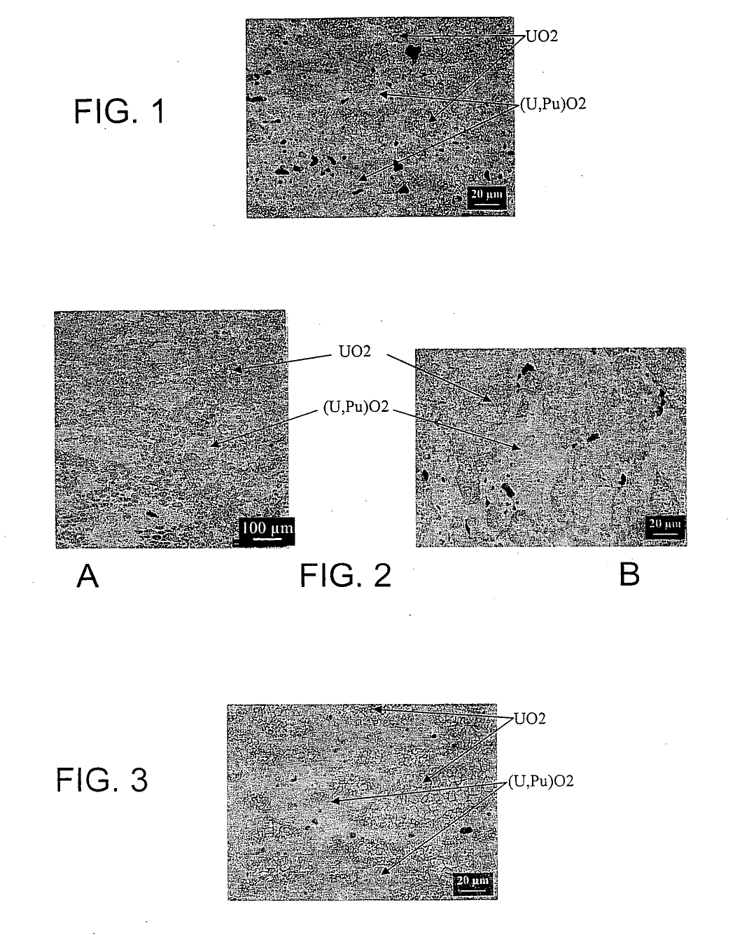

Following this sintering, the pellets were characterized by:
a hydrostatic density equal to 96.3% of the theoretical density which was 11.02;
a microstructure which, as can be seen in FIG. 1, had clusters that were rich in UO₂ (uraniferous phase) dispersed in a matrix containing plutonium (plutoniferous phase);
a volume fraction which was 40% for the uraniferous phase and 60% for the plutoniferous phase in optical microscopy; and
particles of which the mean size was 5 μm in the uraniferous phase and 17 μm in the plutoniferous phase.

As a comparison, control pellets prepared by the same process but without the addition of Cr₂O₃ were characterized by:
a microstructure which, as can be seen in FIG. 2, parts A and B, had clusters that were rich in PuO₂ (plutoniferous phase) dispersed in a uranium-rich matrix (uraniferous phase);
a volume fraction which, on the basis of optical analyses, was 55% for the uraniferous phase and 45% for the plutoniferous phase; and
particles of which the mean size was 5 to 6 μm in the uraniferous phase as in the plutoniferous phase.

Thus, the presence of chromium in pellets prepared in accordance with the invention resulted in a clear reduction in the volume of the uraniferous phase and (U,Pu)O₂ clusters in favour of a covering phase, with an intermediate plutonium content which increased by a factor of 2.

### Example 2

A fraction of the MP1 mixture prepared in example 1 was taken and sieved on a sieve of which the openings measured 250 μm in order to retain only the powder agglomerates with a size less than or equal to 250 μm.

8 g of the undersize were then mixed with 12 g of a UO₂ powder identical to that used to prepare the MP1 mixture, in the presence of 0.04 g of Cr₂O₃ (corresponding to a mass proportion of 2000 ppm) and 0.06 g ZnSt in order to obtain a final mixture of powders having a mass content of plutonium of 11%.

This final mixture was prepared under the same conditions as those described in example 1. Its mass composition was as follows: 88.5% of UO₂, 11% of PuO₂, 0.2% of Cr₂O₃ and 0.3% of ZnSt.

It was then pelleted and the pellets were sintered as described in example 1.

Following this pelleting, the pellets were characterized by:
a hydrostatic density equal to 96.7% of the theoretical density which was 11.02;
a microstructure which, as can be seen in FIG. 3, had clusters that were rich in UO₂ (uraniferous phase) dispersed in a plutonium-rich matrix (plutoniferous phase);
a volume fraction which, on the basis of optical analyses, was 50% for the uraniferous phase and 50% for the plutoniferous phase; and
particles of which the mean size was 5 μm in the uraniferous phase and 15 μm in the plutoniterous phase.

The presence of chromium in pellets prepared according to the invention was therefore the origin of a clear reduction in the volume of the uraniferous phase and of (U,Pu)O₂ clusters in favour of a covering phase, with an intermediate plutonium content which increased by a factor of 1.8.

The pellets were also produced by following the same operational method as that which has just been described, except that the fraction of the MP1 mixture was sieved on a sieve of which the openings measured 80 μm in order to retain only the powder agglomerates with a size less than or equal to this size. This difference in sieving resulted in a slight increase, in the pellets, of the volume fraction of the plutoniferous phase which reached the value of 56%.

### Example 3

8 g of the MP1 mixture prepared in example 1 were stirred with 0.016 g of Cr₂O₃ (corresponding to a mass proportion of 2000 ppm) in a turbine mixer (speed of rotation of the vessel 10 rpm; speed of rotation of the turbine: 3000 rpm) for 3 cycles of 10 minutes each.

The resulting mixture was sieved through a sieve of which the openings had a size of 80 μm so as to retain only powder agglomerates with a size less than or equal to 80 μm.

8.016 g of the undersize were then mixed with 12 g of a UO₂ powder identical to that used to prepare the MP1 mixture, in the presence of 0.024 g of Cr₂O₃ and 0.06 g of ZnSt in order to obtain a final mixture of powders having a mass content of plutonium of 11%.

This final mixture was prepared under the same conditions as those described in example 1. Its mass composition was as follows: 88.5% of UO₂, 11% of PuO₂, 0.2% of Cr₂O₃ and 0.3% of ZnSt.

It was then pelleted and the pellets were sintered as described in example 1.

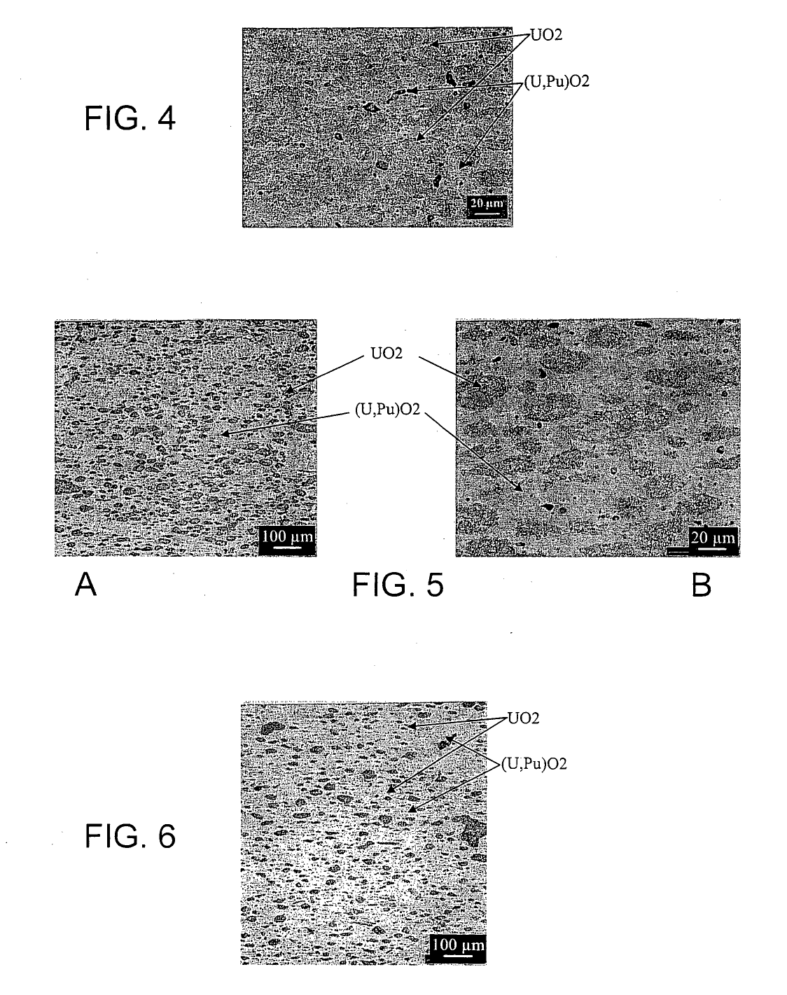

Following pelleting, the pellets were characterized by:
a hydrostatic density equal to 95.9% of the theoretical density (11.02);
a microstructure which, as can be seen in FIG. 4, had clusters that were rich in UO₂ (uraniferous phase) dispersed in a plutonium-rich matrix (plutoniferous phase);
a volume fraction which, on the basis of optical analyses, was 30% for the uraniferous phase and 70% for the plutoniferous phase; and
particles of which the mean size was 5 μm in the uraniferous phase and 16 μm in the plutoniferous phase.

Thus the presence of chromium in the pellets resulted in a clear reduction in the volume of the uraniferous phase in favour of the plutoniferous phase which increased by a factor of 1.6.

### Example 4

A fraction of the MP1 mixture prepared in example 1 was taken and sieved on a sieve with 250 μm openings in order to retain only powder agglomerates measuring at most 250 μm.

8 g of the undersize were then mixed with 12 g of a UO₂ powder identical to that used to prepare the MP1 mixture, in the presence of 0.048 g of UOS (corresponding to a mass proportion of 2400 ppm, that is 270 ppm of elementary sulphur) and 0.04 g of ZnSt so as to obtain a final mixture of powders having a mass content of plutonium of 11%.

This mixture was prepared in a Turbula mixer for a period of 30 minutes and at a speed of 60 rpm.

Its final mass composition was as follows: 88.56% of UO₂, 11% of PuO₂, 0.24% of UOS and 0.2% of ZnSt.

It was then pelleted by means of a hydraulic press at a pressure of 500 MPa. The pellets obtained had a cylindrical geometry characterized by a height and diameter close to 6 mm.

They were then subjected to sintering at 1700° C. in a hydrogen-containing atmosphere (95% Ar/5% H₂) and then humidified with 1000 ppm of water (pH₂/pH₂O˜50).

Following this sintering, the pellets were characterized by
a hydrostatic density equal to 96.4% of the theoretical density (11.02);
a microstructure which, as can be seen in FIG. 5, had clusters that were rich in UO₂ (uraniferous phase) dispersed in a plutonium-rich matrix (plutoniferous phase);
a volume fraction which, on the basis of optical analyses, was 30% for the uraniferous phase and 70% for the plutoniferous phase; and
particles of which the mean size was 5 μm in the uraniferous phase and 13 μm in the plutoniferous phase.

Here also, the presence of sulphur in the pellets resulted in a clear reduction in the volume of the uraniferous phase in favour of the plutoniferous phase which increased by a factor 1.6 to 1.8.

Pellets were also produced by following the same operational method as that which has just been described, except that the fraction of the MP1 mixture was sieved on the sieve of which the openings measured 80 μm so as to retain only powder agglomerates with a size less than or equal to these openings. This difference in sieving resulted in an increase, in the pellets, of the volume fraction of the plutoniferous phase which reached the value of 80%.

### Example 5

8 g of the MP1 mixture prepared in example 1 were taken and stirred with 0.019 g of UOS (corresponding to a mass proportion of 2400 ppm) in a Turbula mixer for 10 minutes at a speed of rotation of the vessel of 60 rpm.

The resulting mixture was sieved on a sieve of which the openings measured 80 μm so as to retain only powdered agglomerates with a size less than or equal to 80 μm.

8.019 g of the undersize were then mixed with 12 g of a UO₂ powder identical to that used to prepare the MP1 mixture, in the presence of 0.029 g of UOS and 0.04 g of ZnSt so as to obtain a final mixture of powders having a mass content of plutonium of 11%.

This mixture was prepared under the same conditions as those described in example 4. Its final mass composition was as follows: 88.56% of UO₂, 11% of PuO₂, 0.24% of UOS and 0.2% of ZnSt.

It was then pelleted and the pellets were sintered as described in example 4.

Following sintering, these pellets were characterized by:
a hydrostatic density equal to 96.4% of the theoretical density (11.02);
a microstructure which, as can be seen in FIG. 6, had clusters that were rich in UO₂ (uraniferous phase) dispersed in a plutonium-rich matrix (plutoniferous phase);
a volume fraction which, on the basis of optical analyses, was 25% for the uraniferous phase and 75% for the plutoniferous phase; and
particles of which the mean size was 5 μm in the uraniferous phase and 10 μm in the plutoniferous phase.

The presence of sulphur in the pellets was therefore the origin of a clear reduction in the volume of the uraniferous phase in favour of the plutoniferous phase which increased by a factor of 1.7.

Table 1 below gives together the previously mentioned values for the volume fractions of the uraniferous and plutoniferous phases determined on the basis of optical analyses (this type of analysis representing the reference method) for pellets produced according to the invention in examples 1 to 5, as well as those of the control pellets described in example 1.

The table also shows values for the volume fractions of these same phases on the basis of electron analyses, more precisely analyses by electron microsound, for pellets produced according to the invention in examples 1, 2 and 4 and for the said control pellets.

These latter values differed substantially from the preceding values, analyses by electron microsound making it possible, in point of fact, to determine the volume fractions for the various phases making up the pellets in a much more precise manner than the reference optical analyses, while taking into account the concentration of each element.

| | Volume fractions (%) - | | Volume fractions (%) - | |
|---|---|---|---|---|
| | optical analyses | | electronic analyses | |
| | Uraniferous | Plutoniferous | Uraniferous | Plutoniferous |
| Pellets | phase | phase | phase | phase |
| Example 1 | 40 | 60 | 21 | 79 |
| Example 2 | | | | |
| sieving to | 50 | 50 | 23 | 77 |
| 250 μm | | | | |
| sieving to | 44 | 56 | — | — |
| 80 μm | | | | |
| Example 3 | 30 | 70 | — | — |
| Example 4 | | | | |
| sieving to | 30 | 70 | — | — |
| 250 μm | | | | |
| sieving to | 20 | 80 | 5 | 95 |
| 80 μm | | | | |
| Example 5 | 25 | 75 | — | — |
| Controls | 55 | 45 | 36 | 64 |

### BIBLIOGRAPHY

[1] EP-A-1 081 716
[2] FR-A-2 738 076 & U.S. Pat. No. 5,841,200
[3] U.S. Pat. No. 6,235,223
[4] WO-A-00/49621
[5] FR-A-2 827 071

1. Process for producing pellets of a nuclear fuel based on a uranium and plutonium mixed oxide or a uranium and thorium mixed oxide having a specified plutonium or thorium content, the said process comprising the following steps:
a) preparing a primary mixture of powders having a plutonium or thorium content greater than the specified content of the fuel, by co-milling a UO₂ powder P1 and a PuO₂ or ThO₂ powder P2,
b) sieving the primary mixture of powders,
c) preparing a final mixture of powders having the specified plutonium or thorium content of the fuel by mixing the undersize obtained in step b) with a UO₂ powder P3 and, optionally, one or more additives,
d) pelleting the final mixture of powders obtained in this way, and
e) sintering the pellets obtained,
and being characterized in that at least one compound chosen from the group consisting of the oxides of chromium, aluminium, titanium, magnesium, vanadium and niobium, precursors thereof and inorganic compounds capable of providing the element sulphur during step e), is/are incorporated in at least one of the powders P1, P2 and P3 and/or into at least one of the primary or final mixtures of powders.

2. Process according to claim 1, characterized in that the compound is chromium sesquioxide (Cr₂O₃) or a precursor thereof.

3. Process according to claim 2, characterized in that, the compound being Cr₂O₃, the mass content of Cr₂O₃ in the final mixture of powders is 500 to 5000 ppm, preferably 1500 to 3000 ppm.

4. Process according to claim 1, characterized in that the compound is an inorganic compound capable of providing the element sulphur during step e).

5. Process according to claim 4, characterized in that the mass content of the final mixture of powders is composed such that it enables 50 to 2000 ppm of elementary sulphur to be provided, preferably 50 to 1000 ppm of elementary sulphur.

6. Process according to claim 5, characterized in that the compound is uranium oxysulphide (UOS).

7. Process according to claim 6, characterized in that the mass content in UOS of the final mixture of powders is 440 to 18000 ppm, preferably 440 to 9000 ppm.

8. Process according to claim 1, characterized in that all or part of the compound is incorporated in the primary mixture of powders during step a) or between step a) and step b).

9. Process according to claim 1 characterized in that all or part of the compound is incorporated in the final mixture of powders during step c).

10. Process according to claim 1, characterized in that the compound is used in powdered form.

11. Process according to claim 1, characterized in that the mass content in plutonium or thorium of the primary mixture of powders is 25 to 35%.

12. Process according to claim 1, characterized in that the mass content in plutonium or thorium of the final mixture of powders is 3 to 12%.

13. Process according to claim 1, characterized in that chamotte is added to the primary mixture of powders and/or to the final mixture of powders.

14. Process according to claim 1, characterized in that the additive or additives mixed with the undersize during step c) is/are chosen from lubricating agents or porogenic agents.

15. Process according to claim 1, characterized in that the pellets are preferably sintered at a temperature of 1700° C. in a gaseous atmosphere leading to an oxygen potential ΔGO₂ of −476 to −372 KJ/mol at the sintering temperature.

16. Process according to claim 14, characterized in that the gaseous mixture is a humidified mixture of argon and hydrogen containing 5% hydrogen and of which the water content is from 100 to 2500 ppm.

17. Pellet of a nuclear fuel based on a uranium and plutonium mixed oxide or a uranium and thorium mixed oxide, capable of being obtained by a process according to claim 1.
